(19) United States
(12) Patent Application Publication
(10) Pub. No.: US 2005/0278999 A1
(43) Pub. Date: Dec. 22, 2005

(54) Replaceable neon bill box

(76) Inventor: David Chiang, Oceanside, CA (US)

Correspondence Address: RAYMOND Y. CHAN, 108 N. YNEZ AVE., SUITE 128, MONTEREY PARK, CA, 91754, US

(21) Appl. No.: 10/874,678

(22) Filed: Jun. 22, 2004

(51) Int. Cl. G09F 13/04

(52) U.S. Cl. 40/575

(57) ABSTRACT

A replaceable bill box includes a light housing, a light source disposed in the light housing, and a replaceable poster cover sized and shaped to fit the front side of the light housing for allowing the light from the light source passing therethrough, wherein the replaceable poster cover. A magnetic mounting arrangement includes a plurality of first magnetic elements spacedly provided on the peripheral rim of the light housing and a plurality of second magnetic elements spacedly provided on the mounting edge of the detachable poster cover to respectively align with the first magnetic elements, wherein the first magnetic elements are magnetically attached to the second magnetic elements respectively to detachably mount the replaceable poster cover in front of the light housing, such that the replaceable poster cover forms an interchangeable advertising board adapted for being replaced with another the replaceable poster cover on the light housing.

### BACKGROUND OF THE PRESENT INVENTION

1. Field of Invention

The present invention relates to a bill box, and more particularly to a neon bill box with a detachable poster panel wherein a user is able to conveniently replace one poster panel to the others by minimal connecting or adhering efforts.

2. Description of Related Arts

Light boxes are extensively utilized for advertisement purposes. A conventional light box usually comprises a main housing, a lighting device disposed in the main housing, and a front cover panel, having a predetermined artistic or atheistic pattern formed thereon, enclosing the main housing in such a manner that high-intensity light generated from the lighting device is arranged to reach an outside of the light box through the front cover panel so as to produce an illuminating advertising effect. Conventional light boxes usually reveal that the lighting device generates the high-intensity light by means of neon gas, i.e. conventional neon light.

A drawback of such a conventional box is that it is inflexible. As a matter of fast-changing nature of commercial practice, one particular advertisement will rapidly become out-of-date. However, the conventional light box is incapable of coping with such a fast-changing nature of advertising practice. For example, when a particular advertisement, which is incorporated with the front over panel, has become out-of-date, it is to be changed and replaced with another updated one. However, changing from one front cover panel to another usually involves time-consuming and hassle procedures, such as extensive unscrewing and re-screwing procedures.

Furthermore, there has been an increasing demand for frequent changing advertisement patterns. For example, a computer-controlled LCD advertising screen is usually deployed in popular spots for conveying a large amount of different advertisements to passers-by. However, such electronic advertisement boards are by no means affordable to the majority of medium and small enterprises.

In light of all these, there is a need for an affordable, easy-changing and hassle-free advertising board to serve the need of rapid-changing nature of ordinary business practice. The replaceable neon bill box of the present invention is definitely such an alternative.

### SUMMARY OF THE PRESENT INVENTION

A main object of the present invention is to provide a replaceable bill box with a replaceable poster cover wherein a user is able to conveniently replace one poster covers to the others by minimal connecting or adhering efforts.

Another object of the present invention is to provide a replaceable bill box which comprises a magnetic mounting arrangement comprising first and second magnetic elements for detachably and conveniently attaching the replaceable poster cover to a light housing of the present invention. In other words, different advertising patterns can be displayed by different replaceable poster covers.

Another object of the present invention is to provide a replaceable bill box, wherein the magnetic mounting arrangement provides not only magnetically engagement but also interlocking arrangement to securely mount the replaceable poster cover in front of the light housing in a detachably mounting manner.

Another object of the present invention is to provide a replaceable bill box which is adapted to generate light by a wide variety of light sources, such as by conventional neon light or other illuminating devices, such as a plurality of LEDs. In any event, the present invention is optimally compatible with the wide variety of light sources.

Another object of the present invention is to provide a replaceable bill box which does not affect the original structure of a conventional neon light box so that the manufacturing cost and the ultimate selling price of the present invention can be kept minimal and mostly affordable.

Accordingly, in order to accomplish the above objects, the present invention provides a replaceable bill box, comprising:
a light housing having a light chamber and a front side defining a peripheral rim therearound;
a light source disposed in the light housing for generating light towards the front side of the light housing;
a replaceable poster cover, having a predetermined light transmisivity, sized and shaped to fit the front side of the light housing for allowing the light from the light source passing therethrough, wherein the replaceable poster cover has a mounting edge corresponding with the peripheral rim of the light housing; and
a magnetic mounting arrangement comprising a plurality of first magnetic elements spacedly provided on the peripheral rim of the front side of the light housing and a plurality of second magnetic elements spacedly provided on the mounting edge of the detachable poster cover to respectively align with the first magnetic elements, wherein the first magnetic elements are magnetically attached to the second magnetic elements respectively to detachably mount the replaceable poster cover on the front side of the light housing so as to enclose the light chamber, such that the replaceable poster cover forms an interchangeable advertising board adapted for being replaced with another the replaceable poster cover on the light housing.

These and other objectives, features, and advantages of the present invention will become apparent from the following detailed description, the accompanying drawings, and the appended claims.

### BRIEF DESCRIPTION OF THE DRAWINGS

FIG. 1 is an exploded perspective view of the replaceable bill box according to a preferred embodiment of the present invention.

FIG. 2 is a sectional side view of the replaceable bill box according to the above preferred embodiment of the present invention.

FIG. 3 is a first alternative mode of the replaceable bill box according to the above preferred embodiment of the present invention.

FIG. 4 is a second alternative mode of the replaceable bill box according to the above preferred embodiment of the present invention.

FIG. 5 is a third alternative mode of the replaceable bill box according to the above preferred embodiment of the present invention.

### DETAILED DESCRIPTION OF THE PREFERRED EMBODIMENT

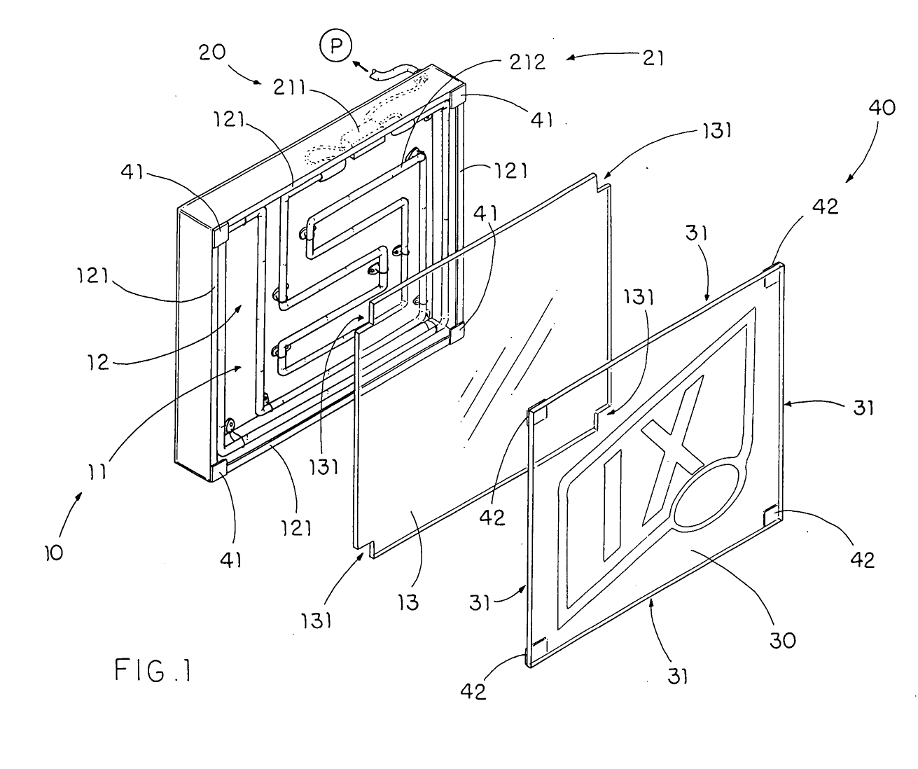

Referring to FIG. 1 of the drawings, a replaceable bill box according to a preferred embodiment of the present invention is illustrated, in which it comprises a light housing 10, a light source 20, a replaceable poster cover 30, and a magnetic mounting arrangement 40.

The light housing 10 has a light chamber 11 and a front side 12 defining a peripheral rim 121 therearound and communicating with the light chamber 11. The light source 20 is disposed in the light housing 10 for generating high-intensity light towards the front side 12 of the light housing 10. According to the preferred embodiment, the light housing 10 is made of lightweight but durable material, such as aluminum, so as to withstand high temperature as a result of high-intensity light generated in the light chamber 11.

The replaceable poster cover 30, having a predetermined light transmisivity, sized and shaped to fit the front side 12 of the light housing 10 for allowing the light from the light source 20 to pass therethrough to reach an outside of the replaceable bill box, wherein the replaceable poster cover 30 has a mounting edge 31 correspondingly aligned with the peripheral rim 121 of the light housing 10.

The magnetic mounting arrangement 40 comprises a plurality of first magnetic elements 41 spacedly provided on the peripheral rim 121 of the front side 12 of the light housing 10, and a plurality of second magnetic elements 42 spacedly provided on the mounting edge 31 of the replaceable poster cover 30 to respectively align with the first magnetic elements 41, wherein the first magnetic elements 41 are arranged to magnetically attached to the second magnetic elements 42 respectively to detachably mount the replaceable poster cover 30 on the front side 12 of the light housing 10 so as to enclose the light chamber 11, such that the replaceable poster cover 30 forms an interchangeable advertising board adapted for being replaced with another replaceable poster cover 30 on the light housing 10.

According to the preferred embodiment, the light source 20 is comprises a neon light unit 21 disposed in the light chamber 11 for generating high-intensity illumination for the replaceable poster cover 30 for highlighting an advertisement pattern formed thereon. The neon light unit 21 comprises a power controller 211 supported in the light chamber 11 and an elongated light tube 212 which is coiled within the light chamber 11 and has two electrode ends connected to the power controller 211 for generating a neon light effect towards the replaceable poster cover 30.

An alternative of the light source 20 is a plurality of Light Emitting Diodes (LEDs) disposed in the light chamber 11 for accumulating high-intensity illumination. In both cases, the light source 20 comprises a power inlet extended from the light chamber 11 out of the replaceable bill box to an external power source P for acquiring electrical power.

Accordingly, the first magnetic elements 41 is made of magnetic material, such as iron, and is arranged to face toward and align with the respective second magnetic element 42 of the replaceable poster cover 30 when the replaceable poster cover 30 is mounted in front of the light housing 10, wherein each of the second magnetic elements 42 is a magnet to magnetically attach to the respective first magnetic element 41 so as to mount the replaceable poster cover 30 in front of the light housing 10.

It is worth to mention that, as an alternative, the second magnetic elements 42 can be made of magnetic material and is arranged to face toward and align with the respective first magnetic element 41 of the light housing 10 when the replaceable poster cover 30 is mounted in front of the light housing 10, wherein each of the first magnetic elements 41 can be a magnet to magnetically attach to the respective second magnetic element 42 so as to mount the replaceable poster cover 30 in front of the light housing 10.

As shown in FIG. 1, the light housing 10 further comprises a transparent protective panel 13 covering at the front side 12 of the light housing 10 to enclose the light chamber 11 for providing physical protection of the light source 20 disposed therein.

The protective panel 13 has a plurality of openings 131 spacedly formed thereon to align with the first magnetic elements 41 respectively when the protective panel 13 is mounted on the front side 12 of the light housing 10 such that the second magnetic elements 42 are magnetically attached to the first magnetic elements 41 through the openings 131 of the protective panel 13 respectively so as to detachably mount the replaceable poster cover 30 on the first side 12 of the light housing 10.

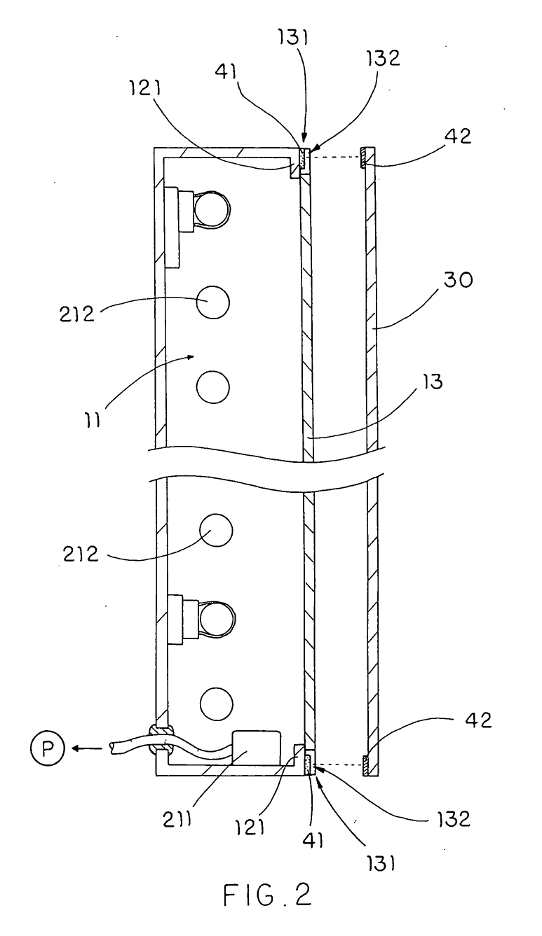

As shown in FIG. 1, each of the openings 131 is formed as a corner opening allow the first magnetic element 41 to magnetically attach to the respective second magnetic element 42 through the opening 131. Accordingly, each of the first magnetic elements 41 has a thickness smaller than a thickness of the protective panel 13 to define an engaging groove 132 within the respective opening 131 when the first magnetic element 41 is disposed in the opening 131 in such a manner that each second magnetic element 42 is arranged to receive in the respective engaging groove 132 when the replaceable poster cover 30 is magnetically attached the light housing 10, so as to minimize a gap between the replaceable poster cover 30 and the protective panel 13, as shown in FIG. 2. In other word, the thickness of the protective panel 13 should be at least smaller than a total thickness of the first and second magnetic elements 41, 42 such that the first magnetic element 41 can be magnetically attached to the respective second magnetic element 42 through the opening 131 of the protective panel 13.

Therefore, it is important to point out that when each of the second magnetic elements 42 is received in the respective engaging grooves 132, thereby magnetically attaching with the respective first magnetic element 41, the distance between the replaceable poster cover 30 and the light housing 10 could be minimized. One advantage of this is that when the distance between the replaceable poster cover 30 and the light housing 10 is minimized, light leaking through that distance would also be minimized, thereby maximizing the light intensity reaching the advertisement pattern on the replaceable poster cover 30. Moreover, with the assistance of the engaging grooves 132, a user is able to conveniently attach the replaceable poster cover 30 on the light housing 10 with a corrected alignment and that they would be readily interlocked with each other for restricting a lateral movement between them. There is also an advantage for this alternative, namely, a reduced manufacturing procedures and cost for forming the engaging grooves 132. In any event however, the first and the second elements 41, 42 are magnetically and detachably bound together.

In the forgoing descriptions, the replaceable poster cover 30 is adapted to be conveniently detached from the light housing 10 and that another replaceable poster cover 30 can be conveniently detached on that light housing for showing different advertisement. Note that the present invention does not require complicated or expensive components, so that it should be readily affordable to most business organizations, and of course with the advantage of considerable flexibility and convenient operation.

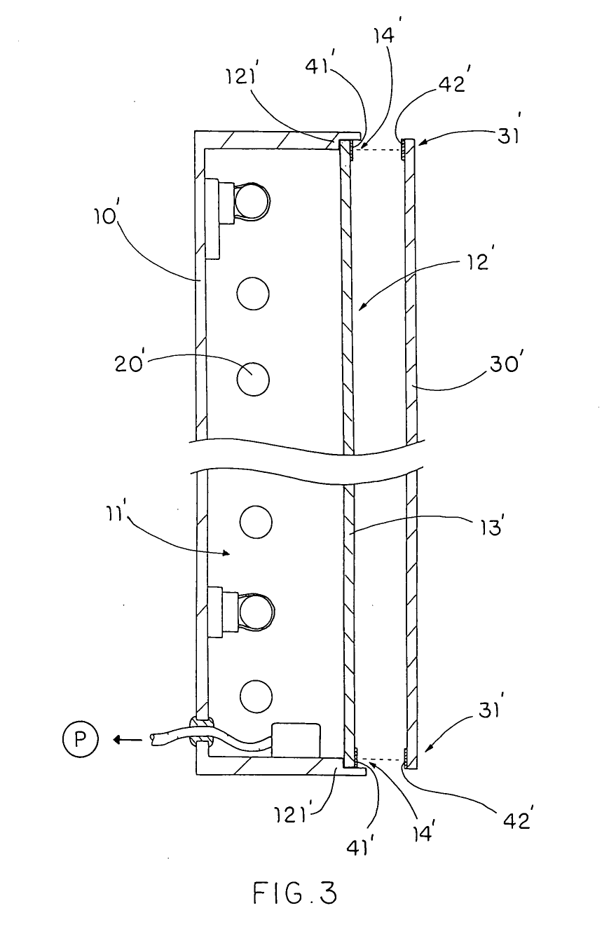

Referring to FIG. 3 of the drawings, a first alternative mode of the present invention is illustrated the interlocking engagement between the light housing 10′ and the replaceable poster cover 30′.

As shown in FIG. 3, the light housing 10′ further has an elongated engaging slot 14′ indently formed along the peripheral rim 121′, wherein the first magnetic elements 41′ are spacedly disposed in the engaging slot 14′ such that the mounting edge 31′ of the replaceable poster cover 30′ is received within the engaging slot 14′ to magnetically attach the second magnetic elements 42′ to the first magnetic elements 41′ respectively so as to detachably mount the replaceable poster cover 30′ in front of the light housing 10′. In other words, the mounting edge 31′ of the replaceable poster cover 30′ is encirclingly received in the engaging slot 14′ so that the replaceable poster cover 30′ is interlocked by the peripheral rim 121′ of the light housing 10′.

The light housing 10′ further comprises a transparent protective panel 13′ covering at the front side 12′ of the light housing 10′ at a position that a surrounding edge of the protective panel 13′ is received in the engaging slot 14′ so as to enclose the light chamber 11′, wherein the first magnetic elements 41′ are spacedly provided at the surrounding edge of the protective panel 13′ such that the second magnetic elements 42′ are magnetically attached to the first magnetic elements 41′ respectively to detachably mount the replaceable poster cover 30′ on the first side 12′ of the light housing 10′. Therefore, the minimum distance between the protective panel 13′ and the replaceable poster cover 30′ can also be sustained.

It is worth to mention that the protective panel 13′ can be optional provided on the front side 12′ of the light housing 10′ for protecting the light source 20′. When the protective panel 13′ is omitted, the first magnetic elements 41′ are spacedly mounted at the peripheral rim 121′ of the light housing 10′ within the engaging slot 14′ such that the second magnetic elements 42′ are magnetically attached to the first magnetic elements 41′ respectively to detachably mount the replaceable poster cover 30′ on the first side 12′ of the light housing 10′. In such a case, the minimum distance between the light source 20′ and the replaceable poster cover 30′ can also be sustained.

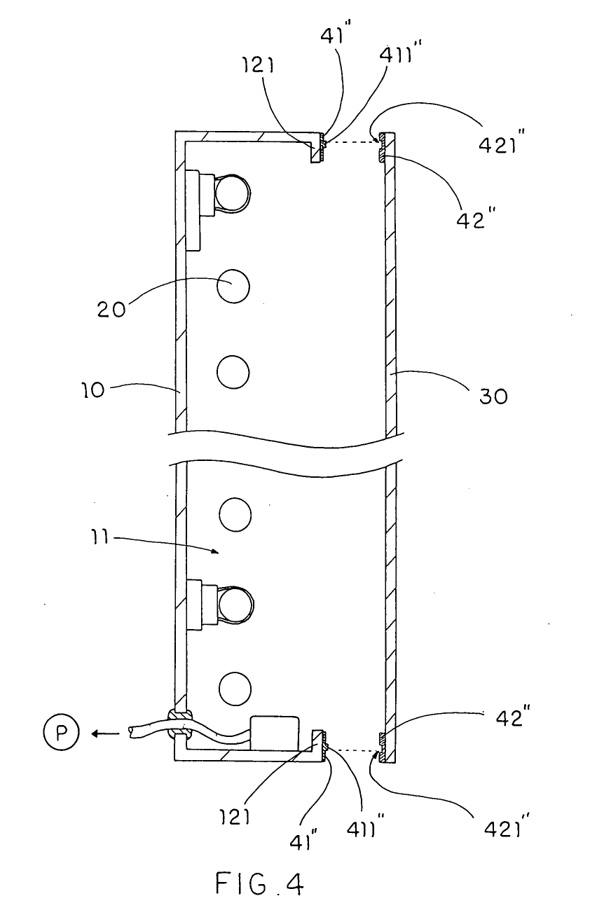

Referring to FIG. 4 of the drawings, a second alternative mode of the present invention is illustrated. According to the second alternative mode, each of the first magnetic elements 41″ has an engaging member 411″ integrally protruded therefrom and each of the second magnetic element 42″ has an engaging groove 421″ indented therefrom and is arranged to face toward and align with the engaging member 411″ of the respective first magnetic element 41″ such that each of the engaging member 411″ is arranged to receive in the respective engaging groove 421″ to interlock the first magnetic element 41″ with the second magnetic element 42″ when the first magnetic element 41″ is magnetically attached the respective second magnetic element 42″ when the replaceable poster cover 30 is detachably mounted in front of the light housing 10.

It is worth to mention that the engaging member 411″ can be formed on the second magnetic element 42″ and the engaging groove 421″ can be formed on the first magnetic element 41″ such that when the first magnetic elements 41″ are magnetically attached to the second magnetic elements 42″ respectively, the engaging member 411″ are arranged to receive in the engaging grooves 421″ respectively so as to interlock the first magnetic elements 41″ with the second magnetic elements 42″.

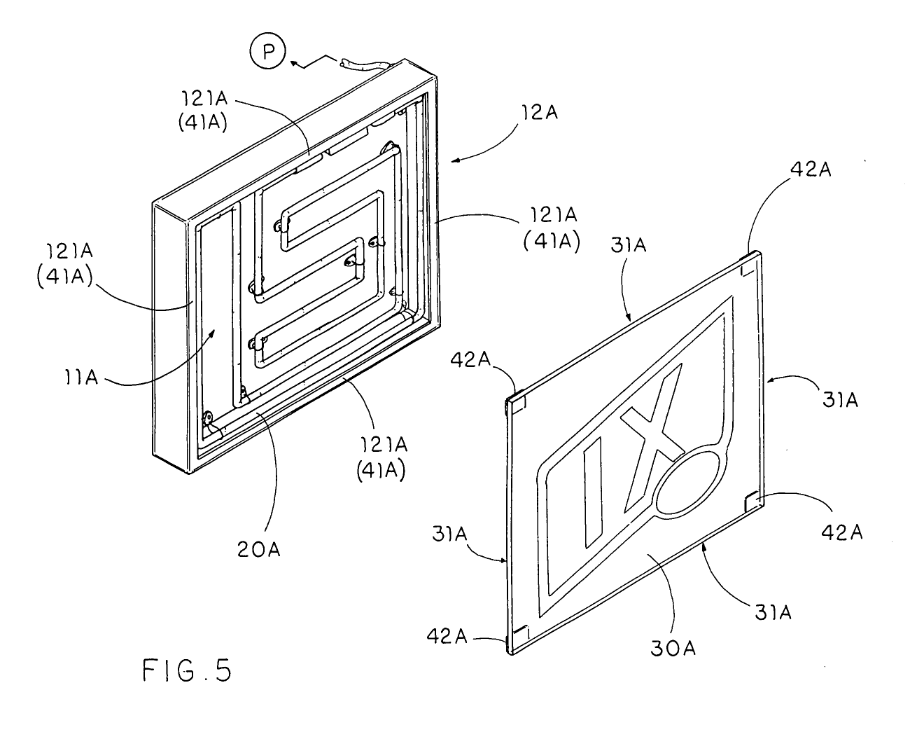

Referring to FIG. 5 of the drawings, a third alternative mode of the present invention is illustrated. The first magnetic elements 41A are integrally formed on the peripheral rim 121A of the light housing 10A that the peripheral rim 121A of the light housing 10A is made of material having magnetic attraction ability, such that the second magnetic elements 42A are magnetically attached to the peripheral rim 121A of the light housing 10A to detachably mount the replaceable poster cover 30A on the first side 12A of the light housing 10A so as to enclose the light chamber 11A for protecting the light source 20A.

Likewise, the second magnetic elements 42A can be integrally formed on the mounting edge 31A of the replaceable poster cover 30A that the mounting edge 31A of the replaceable poster cover 30A is made of material having magnetic attraction ability, wherein the first magnetic elements 41A can be magnets spacedly mounted on the peripheral rim 121A of the light housing 10A to magnetically attached to the mounting edge 31A of the replaceable poster cover 30A so as to detachably mount the replaceable poster cover 30A on the first side 12A of the light housing 10A.

It is worth to mention that, according to the preferred embodiment of the present invention, both the first and the second magnetic elements 41, 42 are embodied as magnetic pieces with different polarity so that magnetic attachment between them can also be substantially achieved.

It is worth mentioning that without violating the spirit of the present invention, the above disclosed preferred embodiment and its alternatives may form a variety of foreseeable combinations and those combinations should be within the scope of the present invention. For example, in the above-mentioned preferred embodiment and its alternatives, both the first and the second magnetic elements 41, 42 are interchangeable that one of the first and the second magnetic elements 41, 42 is a magnet while another one is made of material having magnetic attraction ability, or both be magnetic pieces of different polarities so that they are capable of magnetically yet detachably attaching with each other.

To conclude, the above-mentioned embodiment and its alternatives substantially achieve the objects of the present invention as set forth above.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A replaceable bill box, comprising:
a light housing having a light chamber and a front side defining a peripheral rim therearound;
a light source disposed in said light housing for generating light towards said front side of said light housing;
a replaceable poster cover, having a predetermined light transmisivity, sized and shaped to fit said front side of said light housing for allowing said light from said light source passing therethrough, wherein said replaceable poster cover has a mounting edge corresponding with said peripheral rim of said light housing; and
a magnetic mounting arrangement comprising a plurality of first magnetic elements spacedly provided on said peripheral rim of said front side of said light housing and a plurality of second magnetic elements spacedly provided on said mounting edge of said detachable poster cover to respectively align with said first magnetic elements, wherein said first magnetic elements are magnetically attached to said second magnetic elements respectively to detachably mount said replaceable poster cover on said front side of said light housing so as to enclose said light chamber, such that said replaceable poster cover forms an interchangeable advertising board adapted for being replaced with another said replaceable poster cover on said light housing.

2. The replaceable bill box, as recited in claim 1, wherein said first magnetic elements is made of magnetic material and is arranged to face toward and align with said respective second magnetic element of said replaceable poster cover when said replaceable poster cover is mounted in front of said light housing, wherein each of said second magnetic elements is a magnet to magnetically attach to said respective first magnetic element so as to mount said replaceable poster cover in front of said light housing.

3. The replaceable bill box, as recited in claim 1, wherein said light housing further comprises a transparent protective panel covering at said front side of said light housing to enclose said light chamber so as to protect said light source therein, wherein said protective panel has a plurality of openings spacedly formed thereon to align with said first magnetic elements when said protective panel is mounted on said front side of said light housing such that said second magnetic elements are magnetically attached to said first magnetic elements through said openings of said protective panel respectively so as to detachably mount said replaceable poster cover on said first side of said light housing.

4. The replaceable bill box, as recited in claim 2, wherein said light housing further comprises a transparent protective panel covering at said front side of said light chamber to enclose said light chamber so as to protect said light source therein, wherein said protective panel has a plurality of openings spacedly formed thereon to align with said first magnetic elements when said protective panel is mounted on said front side of said light housing such that said second magnetic elements are magnetically attached to said first magnetic elements through said openings of said protective panel respectively so as to detachably mount said replaceable poster cover on said first side of said light housing.

5. The replaceable bill box, as recited in claim 3, wherein each of said first magnetic elements has a thickness smaller than a thickness of said protective panel to define an engaging groove within said respective opening when said first magnetic element is disposed in said opening in such a manner that each said second magnetic element is arranged to receive in said respective engaging groove when said replaceable poster cover is magnetically attached said light housing, so as to minimize a gap between said replaceable poster cover and said protective panel.

6. The replaceable bill box, as recited in claim 4, wherein each of said first magnetic elements has a thickness smaller than a thickness of said protective panel to define an engaging groove within said respective opening when said first magnetic element is disposed in said opening in such a manner that each said second magnetic element is arranged to receive in said respective engaging groove when said replaceable poster cover is magnetically attached said light housing, so as to minimize a gap between said replaceable poster cover and said protective panel.

7. The replaceable bill box, as recited in claim 1, wherein said light housing further has an elongated engaging slot indently formed along said peripheral rim, wherein said first magnetic elements are spacedly disposed in said engaging slot such that said mounting edge of said replaceable poster cover is received within said engaging slot to magnetically attach said second magnetic elements to said first magnetic elements respectively so as to detachably mount said replaceable poster cover in front of said light housing.

8. The replaceable bill box, as recited in claim 2, wherein said light housing further has an elongated engaging slot indently formed along said peripheral rim, wherein said first magnetic elements are spacedly disposed in said engaging slot such that said mounting edge of said replaceable poster cover is received within said engaging slot to magnetically attach said second magnetic elements to said first magnetic elements respectively so as to detachably mount said replaceable poster cover in front of said light housing.

9. The replaceable bill box, as recited in claim 7, wherein said light housing further comprises a transparent protective panel covering at said front side of said light housing at a position that a surrounding edge of said protective panel is received in said engaging slot so as to enclose said light chamber, wherein said first magnetic elements are spacedly provided at said surrounding edge of said protective panel such that said second magnetic elements are magnetically attached to said first magnetic elements respectively to detachably mount said replaceable poster cover on said first side of said light housing.

10. The replaceable bill box, as recited in claim 8, wherein said light housing further comprises a transparent protective panel covering at said front side of said light housing at a position that a surrounding edge of said protective panel is received in said engaging slot so as to enclose said light chamber, wherein said first magnetic elements are spacedly provided at said surrounding edge of said protective panel such that said second magnetic elements are magnetically attached to said first magnetic elements respectively to detachably mount said replaceable poster cover on said first side of said light housing.

11. The replaceable bill box, as recited in claim 1, wherein each of said first magnetic elements has an engaging member integrally protruded therefrom and each of said second magnetic element has an engaging groove indented therefrom and is arranged to face toward and align with said engaging member of said respective first magnetic element such that each said engaging member is arranged to receive in said respective engaging groove when said first magnetic element is magnetically attached said respective second magnetic element when the replaceable poster cover is detachably mounted in front of said light housing.

12. The replaceable bill box, as recited in claim 2, wherein each of said first magnetic elements has an engaging member integrally protruded therefrom and each of said second magnetic element has an engaging groove indented therefrom and is arranged to face toward and align with said engaging member of said respective first magnetic element such that each said engaging member is arranged to receive in said respective engaging groove when said first magnetic element is magnetically attached said respective second magnetic element when the replaceable poster cover is detachably mounted in front of said light housing.

13. The replaceable bill box, as recited in claim 1, wherein said first magnetic elements are integrally formed on said peripheral rim of said light housing that said peripheral rim of said light housing is made of material having magnetic attraction ability, such that said second magnetic elements are magnetically attached to said peripheral rim of said light housing to detachably mount said replaceable poster cover on said first side of said light housing.

14. The replaceable bill box, as recited in claim 2, wherein said first magnetic elements are integrally formed on said peripheral rim of said light housing that said peripheral rim of said light housing is made of material having magnetic attraction ability, such that said second magnetic elements are magnetically attached to said peripheral rim of said light housing to detachably mount said replaceable poster cover on said first side of said light housing.

15. The replaceable bill box, as recited in claim 1, wherein said second magnetic elements are integrally formed on said mounting edge of said replaceable poster cover that said mounting edge of said replaceable poster cover is made of material having magnetic attraction ability, wherein said first magnetic elements are magnets spacedly mounted on said peripheral rim of said light housing to magnetically attached to said mounting edge of said replaceable poster cover so as to detachably mount said replaceable poster cover on said first side of said light housing.

16. The replaceable bill box, as recited in claim 6, wherein said light source comprises a neon light unit disposed within said light chamber, wherein said neon light unit comprises a power controller supported in said light chamber and an elongated light tube which is coiled within said light chamber and has two electrode ends connected to said power controller for generating a neon light effect towards said replaceable poster cover.

17. The replaceable bill box, as recited in claim 10, wherein said light source comprises a neon light unit disposed within said light chamber, wherein said neon light unit comprises a power controller supported in said light chamber and an elongated light tube which is coiled within said light chamber and has two electrode ends connected to said power controller for generating a neon light effect towards said replaceable poster cover.

18. The replaceable bill box, as recited in claim 12, wherein said light source comprises a neon light unit disposed within said light chamber, wherein said neon light unit comprises a power controller supported in said light chamber and an elongated light tube which is coiled within said light chamber and has two electrode ends connected to said power controller for generating a neon light effect towards said replaceable poster cover.

19. The replaceable bill box, as recited in claim 14, wherein said light source comprises a neon light unit disposed within said light chamber, wherein said neon light unit comprises a power controller supported in said light chamber and an elongated light tube which is coiled within said light chamber and has two electrode ends connected to said power controller for generating a neon light effect towards said replaceable poster cover.

20. The replaceable bill box, as recited in claim 15, wherein said light source comprises a neon light unit disposed within said light chamber, wherein said neon light unit comprises a power controller supported in said light chamber and an elongated light tube which is coiled within said light chamber and has two electrode ends connected to said power controller for generating a neon light effect towards said replaceable poster cover.
